(19) United States
(12) Patent Application Publication
(10) Pub. No.: US 2009/0116495 A1
(43) Pub. Date: May 7, 2009

(54) Method and Device for Dynamic Management of Quality of Service

(75) Inventors: Thierry Lejkin, Paris (FR); Fabio Costa, Paris (FR); Izabella-Marta Rizzetto, Montrouge (FR)

Correspondence Address: COHEN, PONTANI, LIEBERMAN & PAVANE LLP, 551 FIFTH AVENUE, SUITE 1210, NEW YORK, NY, 10176, US

(73) Assignee: France Telecom, Paris (FR)

(21) Appl. No.: 11/992,683

(22) PCT Filed: Sep. 21, 2006
(86) PCT No.: PCT/FR2006/050925

§ 371 Date: Mar. 24, 2008

(30) Foreign Application Priority Data
Sep. 23, 2005 (FR) 0552848

(51) Int. Cl. H04L 12/56

(52) U.S. Cl. 370/395.21

(57) ABSTRACT

A method of dynamically distributing quality of service between users of a network service (3) used by at least one user (1, 2) who has a first quality of service credit. The method includes a step (10) of collecting observation data on the use of the service during a current observation period, a step (13) of applying a quality of service policy associated with a second quality of service credit during a period of use of the service following the current observation period, and a step (11) of computing from said observation data and the first credit the second quality of service credit for the period of use of the service following the collection step (10). A system for dynamically distributing quality of service is also disclosed.

The invention relates to a method of dynamic distribution of quality of service between users of a network service, said service being used by at least one user who has a first quality of service credit.

The field of the invention is that of telecommunications. The invention relates more precisely to quality of service in an IP data network.

It is known to offer services in an IP network to users specifying a certain quality of service. For an Internet access service, for example, the specified quality of service relates to a maximum bit rate.

Network equipments carrying IP streams between users and equipment providing a service to users via the network generally incorporate quality of service functions (see http://www.allot.com/pages/product_overview.asp). One example of a quality of service function is a bandwidth control function known as “shaping” or “rate-limiting” which consists in defining for an element, for example a terminal associated with a user, a maximum authorized bit rate between the terminal and the network. This function guarantees that the bandwidth offered on a network connection shared by a number of users is not used up completely and monopolized by a minority of users who are using bandwidth-hungry services, for example a file downloading service.

These quality of service functions are generally associated with values for verifying whether the quality of service is complied with or not. These values are threshold values, for example, which indicate that quality of service is no longer assured if they are exceeded. With a bandwidth control function, for example, a threshold value is a maximum authorized bit rate for a user. These values are used to trigger a specific quality of service action which, for bandwidth control, consists in limiting the bit rate.

Such equipment provides a large number of quality of service functions and the possibility of managing parameters such as thresholds for activating these functions and triggering quality of service actions in a completely autonomous manner. However, once these parameters have been determined, dynamic modification of the equipment is no longer possible. Consequently, it is not possible to adapt the parameter settings as a function of the real use of the service by users and in particular as a function of a service utilization history.

There are network architectures that include a platform to control or drive data processing equipment in the network (see http://www.tazznetworks.com). Using this kind of control architecture, it is therefore possible to make quality of service processing more dynamic. It is possible to take into account a second element managed by the equipment, for example a user access system, to define a threshold value or parameter of a quality of service function that triggers a quality of service action on the equipment. Likewise, it is possible to use data external to the equipment controlled by the control platform as parameters of a quality of service function that triggers a quality of service action, and such functions can be implemented via the control platform, which is then responsible for recovering the external parameters. These parameters make quality of service management more dynamic because they make it possible to integrate external data for activating quality of service functions in an equipment, for example data present in a database. It is therefore sufficient to modify the external parameters to modify the behavior of the quality of service functions in the equipment.

Dynamic management of quality of service for real-time streams is described in “Supporting Adaptive Flows in a Quality of Service Architecture” by A. Campbell and G. Coulson, MULTIMEDIA SYSTEMS JOURNAL (http://citeseer.ist.psu.edu/campbell96supporting.html). This system uses data feedback from the network to adapt the video stream bit rate to the bandwidth really available instantaneously and aims to guarantee a minimum bandwidth for real-time systems. However, this system does not guarantee equal division of the bandwidth between all users of a service over the period of use of the service. In particular, it favors services that are large consumers of bandwidth to the detriment of services whose bandwidth consumption is intermittent. There is therefore a need for management of division of the bandwidth between users of a service that takes account of how the behavior of users of the service evolves over time. Thus a user who consumes little bandwidth or consumes bandwidth intermittently must be favored over a user who is a large consumer of bandwidth.

To achieve this object, a first aspect of the invention is a method as described in the introductory paragraph comprising:
a step of collecting observation data on the use of the service during a current observation period; and
a step of applying a quality of service policy associated with a second quality of service credit during a period of use of the service following the current observation period;
the method being characterized in that it further comprises:
a step of computing from said observation data and the first credit the second quality of service credit for the period of use of the service following the collection step.

This method has remarkable advantages. A quality of service credit that represents the quality of service to which a user is entitled when using a service is computed after a period of observation of the real use of the service by the user, and a quality of service policy associated with that credit is applied to the user's service traffic. Accordingly, the quality of service policy that is applied to the user's traffic takes account of the user's use of the service up to the present time. Furthermore, in contrast to existing solutions that offer instantaneous equal distribution of bandwidth as a function of the observation of the use of the service that has just been carried out, the method of the invention proposes equal distribution of the bandwidth over a period longer than the last period of observation of the service.

Computing the second quality of service credit, and therefore the associated quality of service policy, depends on a first credit assigned for the current observation period and on the real use of the service during the current observation period. Thus the quality of service policy that is applied during the period of use of the service following the current observation period takes account of the history of the user's use of the service. To be more precise, an average value of the credit really consumed by the user when using the service is taken into account to compute a credit.

Advantageously, for a reference quality of service credit:
the second quality of service credit is less than the first quality of service credit if the use of the service during the current observation period exceeded the reference quality of service credit; and
the second quality of service credit is higher than the first quality of service credit if the use of the service during the current observation period did not exceed the reference quality of service credit.

This computation mode has inherent serious advantages. A reasonable user who uses the service within the limits of the quality of service reference credit during the current observation period is favored in the period of use following the observation period in that they will obtain a second credit higher than their first credit during the current observation period. In contrast, an abusive user who has exceeded the reference credit during the current observation period is assigned a second credit in the period of use following the observation period lower than the one that they had during the current observation period. Accordingly, a number of users who are using the same service are assigned a quality of service that is divided equitably between them.

The steps of the method of the invention are advantageously executed periodically.

Alternatively, the method is triggered by a request.

Another aspect of the invention is a system for dynamically distributing quality of service, comprising a network, a service, at least one user who has a first quality of service credit for the service, and:
means for collecting observation data on the use of the service by the user during a current observation period; and
means for applying a quality of service policy associated with a second quality of service credit during a period of use of the service following the current observation period.

The system is characterized in that it further comprises means for computing from said observation data and the first credit the second quality of service credit for the period of use of the service following the current observation period.

The invention also relates to a network control platform for dynamically distributing the quality of service of a network service used by at least one user who has a first quality of service credit for said service, said platform comprising:
means for recovering and analyzing observation data on the use of the service collected by a quality of service management equipment; and
means for commanding the quality of service management equipment to apply a service policy.

The platform is characterized in that it comprises:
means for computing a second quality of service credit from said observation data on the use of the service and the first quality of service credit; and
means for associating a quality of service policy with the second quality of service credit to be applied to the quality of service management equipment.

The invention also relates to a computer program characterized in that it comprises instructions for collecting observation data on the use of a service during a current observation period by at least one user having a first quality of service credit for said service, instructions for computing from said observation data and the first credit a second quality of service credit for a period of use of the service following the current observation period, and instructions for applying during the period of use of the service following the current observation period a quality of service policy associated with the second quality of service credit.

Numerous details and advantages of the invention can be better understood on reading the description of one particular embodiment with reference to the appended drawings, which are provided by way of non-limiting example, and in which:

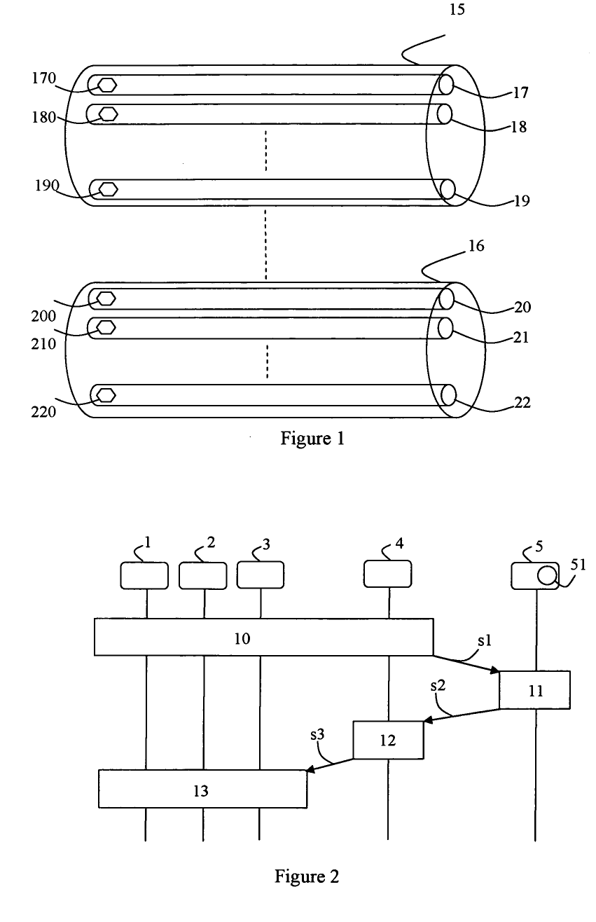

FIG. 1 is a diagram representing how a prior art quality of service equipment is operated in the manner required for the invention;

FIG. 2 shows the dynamic quality of service management method of the invention;

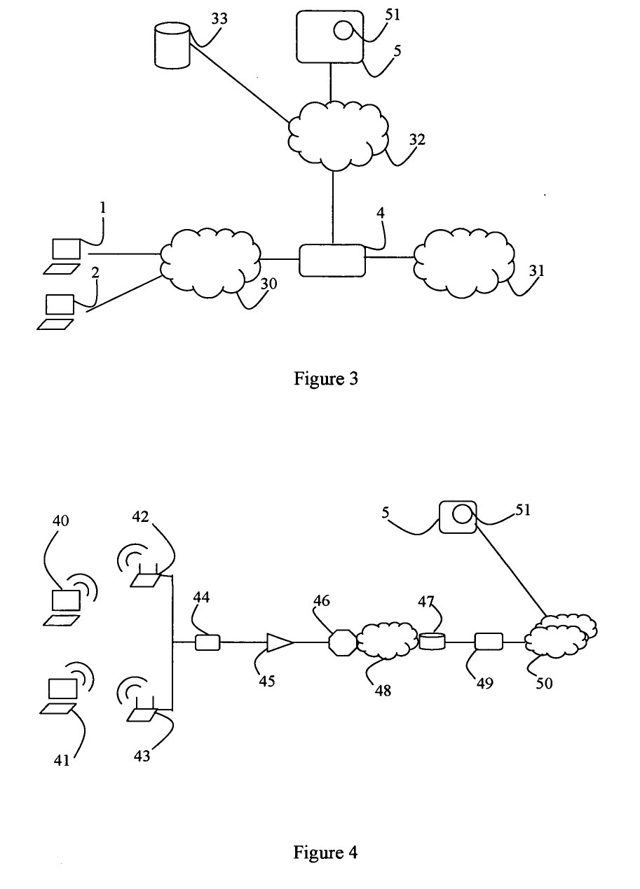

FIG. 3 is one example of a network architecture of the invention;

FIG. 4 is a second example of a network architecture using the method of the invention; an example of an application of the method of the invention is described for this architecture; and

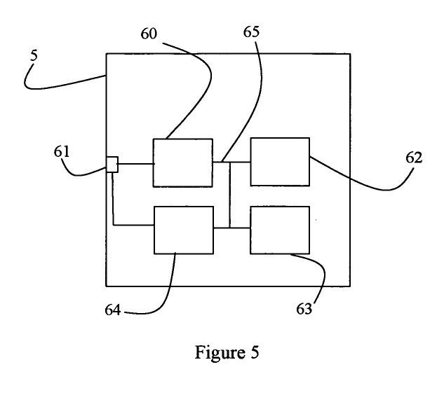

FIG. 5 is a functional representation of a control platform that implements the method of the invention.

The quality of service perceived by a user of a service depends on the functionality offered by the service. For a file downloading service, the perceived quality of service is the time to download a file. The shorter this time, the better the perceived quality of service. For a web portal access service, the perceived quality of service is reflected in effective access to the home page of the portal. For a voice or video streaming service, the perceived quality of service relates to the continuity of the voice or video stream. For example, quality of service is reflected, from the network point of view, in a bit rate, also referred to as bandwidth, expressed in kilobits per second used by a maximum number of users with simultaneous access to a web portal.

The quality of service function, the parameters associated with that function, for example threshold values, and the quality of service actions that are triggered when these threshold values are reached are grouped together under the term quality of service policy. A quality of service policy is said to be applied.

Quality of service credits are also defined for users using a service. A quality of service credit corresponds to what a user is entitled to in terms of quality of service when using the service. One example of a quality of service credit for a service whose quality of service is measured by a bit rate in the network is an average traffic volume for the service for a given period. A credit value corresponds to a quality of service policy to be applied to the traffic of the user concerned. In a standard model, a favorable quality of service policy that can be reflected in a high priority of the user's traffic relating to the service is deemed to correspond to a high quality of service credit. A low traffic priority or a less favorable quality of service policy corresponds to a low quality of service credit.

FIG. 1 is a diagram representing the operation of quality of service management equipment in a prior art network adapted to implement a method of the invention. A traffic regulator or traffic shaper is one example of such equipment. The quality of service management equipment is adapted to classify traffic through it on the basis of the associated users. Classification of the traffic by user is illustrated in the figure by pipes 15 and 16 each representing one classification of the traffic for a user. Two pipes 15, 16 corresponding to the classification of the traffic for two users are shown. Such equipment is of course limited only by the number of associated users. To create such pipes, the equipment executes classification commands or rules. These classification rules are created or deleted either directly in the equipment or via a network control platform. For example, a control platform creates this kind of pipe when a user opens a service session and eliminates this kind of pipe when the user terminates a service session.

An additional classification for the traffic of a user can be produced by such equipment in order to distinguish different types of traffic, for example: transport layer traffic such as User Datagram Protocol (UDP) or Transmission Control Protocol (TCP) traffic, application layer traffic, such as message data transfer traffic based on the Simple Mail Transfer Protocol (SMTP), data transfer traffic based on the HyperText Transfer Protocol (HTTP), or Voice over IP traffic based on the Session Initiation Protocol (SIP). This classification is represented in the figure by the channels 17, 18, 19 for the pipe 15 associated with a first user and the channels 20, 21, and 22 for the pipe 16 associated with a second user.

The quality of service management equipment associates a quality of service policy with each classification represented by a pipe or a channel. The quality of service policies 170, 180, and 190 are associated with the channels 17, 18, and 19, respectively, corresponding to classification by traffic type for the pipe 15 associated with the first user. The quality of service policies 200, 210, and 220 are associated with the channels 20, 21, and 22, respectively, corresponding to classification by traffic type for the pipe 16 associated with the second user. The quality of service policies are preferably determined and assigned to the pipes and channels by the control platform.

The quality of service management equipment analyzes all parameters of packets and data traffic in transit through its interfaces and applies to this traffic quality of service policies with parameters in the form of quality of service functions set by a network operator responsible for managing the network from the control platform.

Moreover, the quality of service management equipment observes traffic that passes through it and sends another network equipment, for example the control platform, observation data relating to the traffic that passes through it, for example: an average volume of data uploaded or downloaded, an average bit rate, details of the user's traffic. The choice of observation data that is fed back is made by the control platform and is a parameter of the platform. The quality of service management equipment sends this observation data to the control platform either spontaneously (this is referred to as a “push” method), for example according to a parameter that represents a regular time interval, or following a request from the control platform (this is referred to as a “pull” method).

FIG. 2 shows the steps of the method of the invention. Users 1 and 2 access a service 3 via an IP packet network (not shown in the figure). The service can be any service provided via an IP network, for example an Internet access service, a video streaming service, a sound, video or image media downloading service. A quality of service management equipment 4 installed in said network classifies the traffic that passes through it for the users 1 and 2 and observes the use of the service 3 by the users 1 and 2 in the manner described for a prior art quality of service management equipment. The quality of service management equipment 4 collects observation data for the use of the service 3. A control platform 5 installed in the network controls telecommunication equipment installed in the network, for example the quality of service management equipment 4. The control platform 5 includes a module 51 for dynamic management of quality of service in accordance with the invention. The module 51 advantageously includes a program stored in a memory of the control platform 5.

The figure shows two users. The invention is not limited by the number of service users, as a single user can equally well use the service, although the method of the invention is more advantageous when several users use the service. Similarly, the figure shows only one service. The invention is not limited by the number of services whose use can be observed by the quality of service management equipment 4.

Initially, when opening a session in respect of the service 3, each user 1, 2 has an initial quality of service credit for the service that is a parameter of the dynamic quality of service management method of the invention. The initial quality of service credit corresponds to the quality of service entitlements of the users 1 and 2 when they use the service 3 in a normal mode of operation.

In an alternative embodiment of the invention that is not shown, the initial credits of the users 1 and 2 are stored in one or more databases to which the control platform 5 has access. The control platform then recovers the initial credit of a user by means of a request, for example when opening a service session for that user. A service can advantageously send service requests to the control platform 5, for example to signal the start of a service session for the user and the end of the service session for that user. The control platform 5 uses these service requests to compute or recover the initial quality of service credit of said user.

In an initial step 10, the users 1 and 2 use the service 3. The quality of service management equipment 4 observes the use that is made of the service 3 during a current observation period and collects for each user observation data for the use of the service 3, for example an average volume of data downloaded or uploaded, an average bit rate, details by traffic type, for example details relating to Voice over IP, HTTP or SMTP-type data transfer traffic. During the current observation period, the users 1 and 2 have a first quality of service credit that corresponds to the quality of service they are entitled to during the current observation period. During opening of the service session by the users 1 and 2, the first quality of service credit corresponds to their initial credit. At the end of the step 10, corresponding to the end of the current observation period, the data collected by the quality of service management equipment 4 is fed back to the control platform 5. This feedback of observation data is illustrated by the sending of a message s1. For reasons of clarity, the step 10 in the figure ends with sending the message s1 that contains the observation data for use of the service 3 during the current observation period, the duration of this observation period being a time parameter fixed by the control platform. Observation of use of the service 3 by the users 1 and 2 continues, of course, and observation data for their use of the service 3 is sent at the end of a subsequent observation step that is not shown. In an alternative embodiment of the invention (not shown) feedback to the control platform 5 of observation data on use of the service 3 follows the control platform 5 sending an observation data request.

In a step 11, following reception by the control platform 5 of the message s1 that contains the observation data for use of the service 3 by the users 1 and 2 during the current observation period, the control platform 5 computes a second quality of service credit for the users 1 and 2. The second quality of service credit associated with a user corresponds to the quality of service to which the user is entitled for a period of use of the service following the current observation period. The second quality of service credit is computed from the observation data on the use of the service 3 fed back from the quality of service equipment 4 to the platform 5 at the end of the step 10 and the first quality of service credit, which is the credit that the users have during the current observation period. Accordingly, the second quality of service credit associated with a user represents the use that said user has made of the service during the current observation period. The computation being effected at the end of each current observation period, the second credit assigned to a user in real time takes account of the history of the use of the service from opening the service session.

To each possible value of the quality of service credit there corresponds a quality of service policy to be applied to the traffic of the user concerned during the period of use of the service following the current observation period.

In an advantageous embodiment of the invention, determining the quality of service policy to be applied to the traffic of a user for the second quality of service credit takes into account a profile of the user: for example, a service manager type user can have the benefit of a favorable quality of service policy during a service session that they initiate because the service session relates to a high priority service maintenance operation.

By way of non-limiting example, a quality of service credit computation algorithm for a service whose quality of service is measured by a volume of data per unit time is based on the following formula:

credit_variation=k*(normal_volume−real_volume);
in which k is a positive constant, normal_volume is a reference volume for the service traffic concerned, and real_volume is the user's actual volume of traffic during the current observation period. The normal_volume corresponds to a reference quality of service credit. For example, the normal_volume can be associated with the initial quality of service credit. The real_volume is information fed back by the quality of service management equipment 4 in the message s1. The second credit is then calculated by adding credit_variation to the first credit associated with the current observation period. The second credit is advantageously in a range between a minimum value min_credit, for example equal to 0, and a maximum value max_credit.

Once the second quality of service credit has been computed, the control platform 5 has to determine a quality of service policy to be applied to the service traffic of the user concerned. A quality of service policy is associated with each possible value of the new credit. By way of non-limiting example, the quality of service policy is a value corresponding to a traffic priority that is a number between a minimum priority value min_priority, which can be equal to 0, and a maximum priority value max_priority. The value of the quality of service policy num_priority is computed as:

num_priority=(new_credit/max_credit)*max_priority;
rounded to the nearest integer.

In alternative embodiments of the invention, not described, more complex models for computing credits or priorities can be considered. Computation can be based on non-linear formulas, for example.

At the end of the step 11, the control platform 5 sends the quality of service management equipment 4 a control message s2 for implementing the quality of service policy associated with the second credit determined in the step 10.

In a step 12, following reception of the control message s2 for implementing the quality of service policy, the quality of service management equipment 4 applies the quality of service policy for the service 3 to the users 1 and 2, as represented in the figure by a message s3.

In a step 13 corresponding to use of the service following the current observation period, the quality of service policy associated with the second credit is applied for the service 3 to the service traffic concerning the users 1 and 2.

It is clear that the method defined by the steps 10 to 13 is executed continuously during use of the service 3. Thus a period of use of the service following a period of observation of the use of the service, illustrated by the step 13, sees collection of observation data for the use of the service 3 by the quality of service management equipment 4 and feedback of observation data to the control platform 5, as in the step 10.

FIG. 3 is an example of a network architecture that implements the method of the invention. Users 1, 2 access a service (not shown) using a first network 30. Uplink or downlink traffic between the service and the users 1, 2 passes through a quality of service equipment 4 adapted to apply quality of service policies. Only one equipment 4 is shown. The invention is not limited to only one quality of service equipment installed in the network. Similarly, two users are shown but the invention is not limited to two users. The quality of service equipment 4 is connected to a second network 31 that provides the service. A control platform 5 according to the invention recovers observation information on the use of the service by the users 1 and 2 from the quality of service equipment 4 and controls that equipment. The control platform includes a dynamic quality of service management module 51 of the invention. In this architecture example, the quality of service equipment 4 is controlled by the control platform via an intermediate network 32. A database 33 accessible via the control platform 5 supplies at the request of said control platform 5 data specific to the user or the service, for example an initial quality of service credit, a user profile.

FIG. 4 is a second example of an architecture that implements the method of the invention and an example of the use of the method of the invention with a service. The architecture is that of a wireless Internet access service (for example, a WiFi (Wireless Fidelity) hot spot), in which users 40, 41 share an ADSL (Asynchronous Digital Subscriber Line) connection. The users 40, 41 access the Internet via wireless access points 42, 43 connected to a modem-router 44. The modem-router 44 sets up the ADSL connection with a first digital subscriber line access multiplexer (DSLAM) 45 responsible for multiplexing streams to the transport network. Behind this first equipment 45 is a second equipment 46 for data transport management which groups traffic coming from around ten DSLAMs 45. This second equipment 46 is a broadband access server (BAS). The BAS 46 establishes a persistent tunnel with a third equipment 47 which is an L2TP Network Server (LNS) router via one or more networks 48. The traffic passes in transit in both directions via fourth equipment 49 (quality of service equipment) and thereafter joins other networks 50, including the Internet, for example. In the figure, the quality of service equipment 49 is a traffic shaper. A control platform 5 of the invention dialogues via the other networks 50 with the fourth equipment 49 to implement the method of the invention. The control platform 5 includes a dynamic quality of service management module 51 according to the invention.

In an alternative embodiment of the method of the invention, the control platform 5 receives requests relating to services, for example requests to open and close service sessions, sent by elements of the network not shown in the figure, for example web portals or other services. Support databases not shown in the figure, for example databases of an information system, can also interact with the control architecture to supply parameters specific to the users of the service.

It is assumed that the bit rate available in the downlink direction, i.e. from the network to the users, is x kilobits/second for the ADSL connection, that the users 40, 41 have identical profiles, that they have identical initial quality of service credits, and that they are using the same service at a certain time. The user 40 requests the maximum possible downlink bit rate for m minutes, during which m minutes the user 41 carries out the following operations:
Requesting a downlink bit rate of y kilobits/second for n minutes, where n<m, y<x/2, for example requesting for n minutes a video streaming session that does not require a bit rate higher than x/2.
Then, during the remaining m−n minutes, the user 41 requesting the maximum possible bit rate, for example to download a file from a server that offers a very high download speed.

Using the method of the invention, the bit rates obtained by the users 40 and 41 during the period of m minutes are as follows:
The user 41 obtains y kilobits/second for n minutes. At the beginning of the period, both users have the same quality of service credit x/2, since there are no other users and the bit rate offered is x kilobits/second. The user 41 requests for n minutes a lower bit rate than that allowed by his or her credit. The user 41 therefore has all the necessary credit to obtain the video stream for those n minutes, i.e. y kilobits/second. During these n minutes, the credit of the user 41 can only remain higher than that of the user 40, and this user therefore obtain that bit rate throughout the period of n minutes.
The user 40 obtains x−y kilobits/second for n minutes. The user 40 requests the maximum possible bit rate, i.e. all the bit rate that is not being used by the user 41.

The user 41 then requests the maximum bit rate for m−n minutes. Because the architecture implements the invention, the credit of the user 41 is either increased or reduced, although it remains strictly higher than that of the user 40. The users 40 and 41 are now in competition to obtain a maximum bit rate, but the user 41 has a higher credit than the user 40 and therefore obtains a bit rate w>x/2, while the user 40 obtains the remaining bit rate, namely x−w<x/2.

Accordingly, in the second phase, although the user 41 requests the maximum bit rate, the user 41 is able to recover a portion of the bit rate that they did not use during the first phase. The user 40 obtains a lower bit rate in the second phase, because they used more bit rate than they were entitled to in the first phase: they were granted this bit rate because no other user was using it during this period of time.

Use of the quality of service credit in terms of bit rate is thus balanced between the users 40 and 41: the user 40 obtains the maximum bit rate provided that it is not used, and a lower bit rat when the user 41 wishes to access a service. Having used very little bit rate at the start of the period, the user 41 merits a greater bandwidth in the second period.

Thus sharing of bandwidth is balanced between the users 40 and 41 and takes account of the use that each has made of the bandwidth.

FIG. 5 is a functional representation of a control platform 5 that implements the method of the invention. The control platform 5 includes a number of modules:
A module 60 for recovering and analyzing observation data on the use of a service adapted to receive observation data on the use of a service by one or more users from a quality of service management equipment of the network via a network interface 61. Using this observation data the module 60 analyses the traffic data and correlates the use of a service by a number of users, for example to study the distribution of bandwidth usage.
A module 62 for computing a new quality of service credit from observation data on the use of a service recovered by the module 60 and an initial quality of service credit that is a parameter of the module 62. In an alternative embodiment of the control platform that is not shown, the parameter is in an external database and is recovered by the module 62 by means of a request to the database.
A module 63 for associating the new credit with a quality of service policy to be applied to the service traffic for a current period of use of the service.
A quality of service management equipment control module 64 for commanding said equipment to implement the new quality of service policy identified by the module 63.

These modules communicate with each other via an internal communication bus 65.

1. A method of dynamically distributing quality of service between users of a network service (3) used by at least one user (1, 2) who has a first quality of service credit, the method comprising:
a step (10) of collecting observation data on the use of the service during a current observation period;
a step (13) of applying a quality of service policy associated with a second quality of service credit during a period of use of the service following the current observation period; and
a step (11) of computing from said observation data and the first credit the second quality of service credit for the period of use of the service following the collection step (10).

2. The method according to claim 1, wherein for a reference quality of service credit:
the second quality of service credit is less than the first quality of service credit if the use of the service during the current observation period exceeded the reference quality of service credit; and
the second quality of service credit is higher than the first quality of service credit if the use of the service during the current observation period did not exceed the reference quality of service credit.

3. The method according to claim 1, wherein the steps of the method are executed periodically.

4. The method according to claim 1, wherein the method is initiated by a request.

5. A system for dynamically distributing quality of service with a network, a service, and at least one user who has a first quality of service credit for the service, wherein the system comprises:
means for collecting observation data on the use of the service by the user during a current observation period;
means for applying a quality of service policy associated with a second quality of service credit during a period of use of the service following the current observation period;
means for computing from said observation data and the first credit the second quality of service credit for the period of use of the service following the current observation period.

6. A network control platform for dynamically distributing the quality of service of a network service used by at least one user who has a first quality of service credit for said service, said platform comprising:
means (60) for recovering and analyzing observation data on the use of the service collected by a quality of service management equipment (4);
means (64) for commanding the quality of service management equipment to apply a service policy;
means (62) for computing a second quality of service credit from said observation data on the use of the service and the first quality of service credit; and
means (63) for associating a quality of service policy with the second quality of service credit to be applied to the quality of service management equipment.

7. A computer program comprising instructions for collecting observation data on the use of a service during a current observation period by at least one user having a first quality of service credit for said service, instructions for computing from said observation data and the first credit a second quality of service credit for a period of use of the service following the current observation period, and instructions for applying during the period of use of the service following the current observation period a quality policy associated with the second quality of service credit.
